(19) United States
(12) Patent Application Publication
(10) Pub. No.: US 2015/0006889 A1
(43) Pub. Date: Jan. 1, 2015

(54) ACADEMIC QUIZ-PACK SUITE ADMINISTRATION BASED ON DIGITAL RIGHTS MANAGEMENT SERVICE

(71) Applicant: Konica Minolta Laboratory U.S.A., Inc., San Mateo, CA (US)

(72) Inventor: Rabindra Pathak, San Jose, CA (US)

(21) Appl. No.: 13/931,999

(22) Filed: Jun. 30, 2013

(51) Int. Cl. G06F 21/62; H04L 29/06

(52) U.S. Cl. CPC G06F 21/6218; H04L 63/10
USPC 713/165; 726/28; 726/1

(57) ABSTRACT

A method for managing access and use of quiz-packs by users of course-packs which may are accessed and displayed by a client application, comprising the steps of establishing a database with entries of correlating course-pack and quiz-pack identifications (IDs) and pre-conditions for using respective quiz-packs, providing a plug-in program to the client application, the plug-in program tracking and reporting users' course-pack usage information, upon a user's request for accessing and using a quiz-pack associated with a course-pack, determining whether the user has appropriate rights to access and use the quiz-pack based on the entries of the database, and also determining whether all pre-conditions are met for the user to access and use the quiz-pack based on the reported course-pack usage information, and if the user is determined to have appropriate rights and all pre-conditions are met, authorizing the user's access and use of the quiz-pack, and when receiving the authorization to the user's access and use of the quiz-pack, the plug-in program displaying the quiz-packs.

### BACKGROUND OF THE INVENTION

1. Field of the Invention

This invention relates to a method of managing electronic academic documents, and in particular, it relates to a method for managing electronic course-pack and quiz-pack documents protected by digital rights management (DRM).

2. Description of Related Art

Academic and educational documents are nowadays often prepared, produced, assembled and disseminated in electronic digital file formats such as the Portable Document Format (PDF). For example, a traditional hard-copy course book may be replaced by a course-pack suite of PDF documents, which can be opened and displayed by PDF file reader applications such as Adobe®'s Acrobat Reader. Likewise a traditional hard-copy quiz sheet may be replaced by a quiz-pack suite of PDF documents, which can also be handled by PDF file reader applications that would allow a user to fill-in his or her answers or choices.

More and more educational institutions are implementing or engaging rights management service (RMS) to manage access and use of DRM protected electronic documents. For example, when a student purchases a PDF course-pack document, the user's identification and rights to open, read or copy the course-pack document can be handled by an RMS which will allow the student to access and use the course-pack with the rights assigned to the student (e.g., open and read the course-pack), while restricting unauthorized uses by the student (e,g., print and copy).

Typically when a user opens a PDF document by using a client program such as a PDF reader, the client can check to see whether the file is DRM-protected. If the file is DRM-protected, then the client will ask the user to provide a user ID (and password), and check the user ID with an RMS system by accessing an RMS server via a computer network such as the Internet. The RMS system can verify the user's ID with a database maintained at the server to determine the user's rights in connection with the PDF document, and inform the client what rights are granted to the user with regard to the PDF document.

With the increasing use of DRM protected digital course-pack documents in connection with RMS systems, there is a need to provide more quiz-pack documents also in digital formats, to associate the quiz-pack documents with their corresponding course-pack documents, and to provide the quiz-pack documents with the same level of protection as the course-pack, so that quiz-packs can be more easily and readily used by users in conjunction with their studying of the corresponding course-packs.

### SUMMARY

The present invention is directed to a new method of managing academic quiz-pack suites based on digital RMS systems.

An object of the present invention is to provide the same level of DRM protection to academic quiz-packs as provided to the academic course-packs.

Another object of the present invention is to ensure that the quiz-packs are available for use only after certain preconditions related to corresponding course-packs are met.

Additional features and advantages of the invention will be set forth in the descriptions that follow and in part will be apparent from the description, or may be learned by practice of the invention.

The objectives and other advantages of the invention will be realized and attained by the structure particularly pointed out in the written description and claims thereof as well as the appended drawings.

To achieve these and/or other objects, as embodied and broadly described, one of the exemplary embodiments of the present invention provides a method for managing access and use of quiz-packs by users of course-packs which may are accessed and displayed by a client application, comprising the steps of establishing a database with entries of correlating course-pack and quiz-pack identifications (IDs) and pre-conditions for using respective quiz-packs, providing a plug-in program to the client application, the plug-in program tracking and reporting users' course-pack usage information, upon a user's request for accessing and using a quiz-pack associated with a course-pack, determining whether the user has appropriate rights to access and use the quiz-pack based on the entries of the database, and also determining whether all pre-conditions are met for the user to access and use the quiz-pack based on the reported course-pack usage information, and if the user is determined to have appropriate rights and all pre-conditions are met, authorizing the user's access and use of the quiz-pack, and when receiving the authorization to the user's access and use of the quiz-pack, the plug-in program displaying the quiz-packs.

In a further aspect, another one of the exemplary embodiments of the present invention provides a computer software program product that causes one or more data processing apparatus to perform the above described methods. The computer program product includes at least one computer usable non-transitory medium (e.g. a memory or storage device) having computer readable codes embedded therein for controlling the one or more data processing apparatus, the computer readable codes configured to cause the one or more data processing apparatus to execute the above described processes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online environment according to one of the embodiments of the present invention.

FIG. 2 is a schematic block diagram illustrating another exemplary online environment according to one of the embodiments of the present invention.

FIG. 3 is a schematic block diagram illustrating an exemplary data processing apparatus such as a computer or server having a data processing unit according to one of the embodiments of the present invention.

FIG. 4 is a schematic block diagram illustrating one of the exemplary embodiments of the present invention.

FIG. 5 is a schematic block diagram illustrating another one of the exemplary embodiments of the present invention.

### DETAILED DESCRIPTION OF PREFERRED EMBODIMENTS

Embodiments of the present invention provide a method for protecting and managing academic quiz-pack suite. RMS systems have been utilized to protect academic digital course-packs, so that only authorized users can access and use the course-packs. With the addition of quiz-packs, educators can test students by providing them quiz-packs associated with corresponding course-packs. By associating the quiz-packs with their corresponding course-packs, and providing the same level of DRM-protection to quiz-packs, the effectiveness and efficiency of the education process can be improved. Particularly, the embodiments of the present invention provide a mechanism to utilize RMS systems for protecting quiz-packs, associating quiz-packs with their corresponding course-packs, and also managing the access and use of the quiz-packs so that students may take quizzes only after they fulfill certain criteria or preconditions in connection with the course-pack, which may be applied based on metadata from an RMS or Learning Management Services (LMS) system or manually configured by the administrator of an RMS or LMS system.

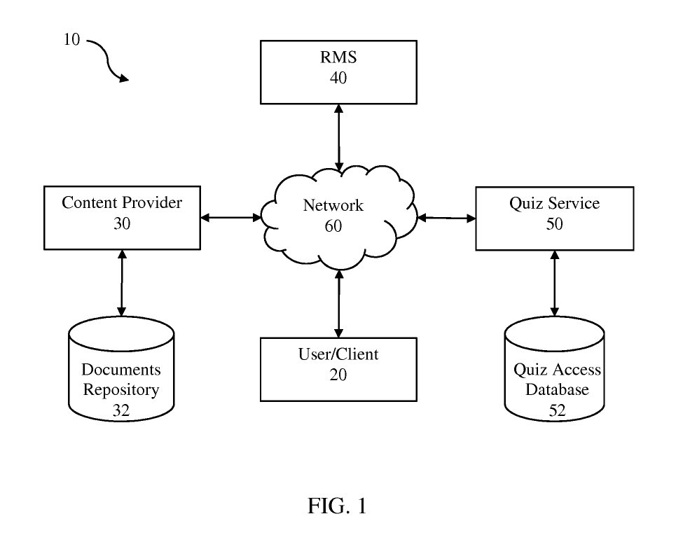

Referring to FIG. 1, there is shown a schematic block diagram illustrating an exemplary arrangement 10 in which various embodiments of the present invention may be implemented.

The exemplary environment 10 includes a user terminal or a client program running on a user's terminal 20, a content provider server 30 connected to an electronic document repository 32, an RMS server 40, and a quiz-pack service server 50 connected to a quiz access database 52, all connected through a network 60 which may include a computer network such as the Internet or other communication links.

When computer network such as the Internet is utilized, a user may use a user computer or terminal 20, or similar suitable devices such as a laptop computer, a tablet computer, an e-reader, or a smart phone, etc., to access the computer network 60 and interact with the content provider server 30, the RMS server 40 and the quiz service server 50, etc. For example, a user may purchase and download a course-pack document in PDF from the content provider server. When a user tries to open the course-pack from the user's computer by using a client program such as a PDF file reader, the client will contact the RMS server to obtain authorization for the user, and then displays the content of the PDF course-pack on the user's computer. Likewise, the user may obtain a quiz-pack associated with the course-pack from the content provider server. When the user wants to takes the quiz and tries to open the quiz-pack from the user's computer, a plug-in module to the client program can contact the quiz service server to obtain authorization for the user, and also check to see whether all pre-conditions for the user to take the quiz are met, and then displays the content of the PDF quiz-pack on the user's computer for the user to take the quiz.

The content provider server 30 may be operated by, for example, an educational institution, an LMS provider, etc., which generally provides online electronic documents, books, booklets, course-packs, publications and other materials in digital files. The content provider server 30 may provide an integrated online service platform such as an online course or webstore that allows users to search, access, upload or download, and purchase electronic documents stored as digital files in its internal storage device and/or in the document repository 32.

The RMS server 40 may be operated by a DRM center, a copyrights management center or other commercial establishments. The LMS server 30 and the RMS server may be the same server (operated by a same entity). When an electronic document is purchased by a user in a digital file, the RMS server may enable appropriate DRM protection to the document such that only the user who has purchased the document may have appropriate rights to access and view the document.

The quiz service server 40 may be operated by a quiz service provider, a test preparation center or other commercial establishments. When a DRM-protected quiz-pack is purchased by or otherwise provided to a user, the quiz service server will manage the user's rights to access, view and use the quiz-pack document.

Details of the interactions of the various parties shown in FIG. 1 will be described in conjunction with the following disclosures and descriptions.

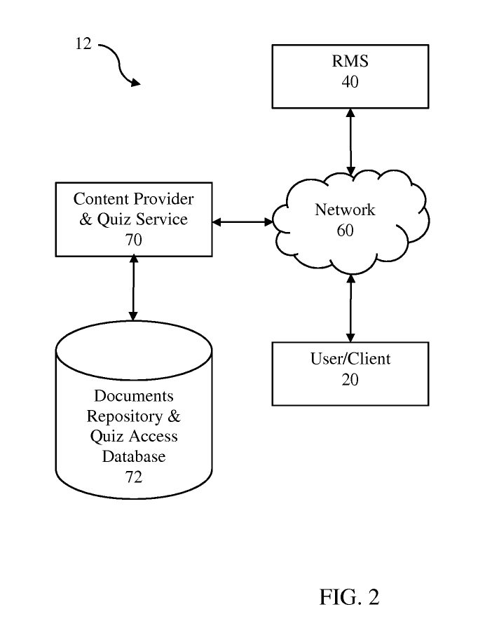

As shown in FIG. 2, in an alternative arrangement 12, the content provider server and the quiz servicer server may be the same server 70 operated by a same entity such as an educational institute or a commercial establishment. In this alternative arrangement the document repository and the quiz access database may be maintained on a same memory or data storage device 72.

The computers, terminals and servers shown in FIGS. 1 and 2 may be computers, server computers, or computer or server systems, including webservers, where the computer software programs, applications or plug-in modules implementing the various processes of the exemplary embodiments of the present invention may be installed and executed. These programs, applications or plug-ins also provide appropriate user interfaces (US) or graphic user interfaces (GUI) to allow users and administrators/operators to interact with the computer/servers to perform various steps of the process.

The physical locations or the commercial relationship among the various parts of the environment shown in FIGS. 1 and 2 are not important. For example, the server of the LMS server 30 and/or the RMS server 40 may be located in an educational institution, an organization or a commercial establishment.

In this Application, the term “server” generally refers to any computer, server, server computer, server instance, computer or server system, data processor, controller, data processing unit or apparatus, or any suitable system, apparatus or device, and any computer software program or application that are installed or executed on such system, apparatus or device, that may be used to implement the methods or carry out the processes provided by the embodiments of the present invention. However, in this Application the term “client” specifically refers to a computer software program or application that is used by a user to open, display/read or otherwise use (such as print and copy) an electronic document. For example, for PDF documents, the client may be a PDF reader such as Adobe®'s Acrobat Reader.

As mentioned earlier, in one aspect, an exemplary embodiment of the present invention is embodied a computer program product that causes a data processing apparatus to perform the exemplary embodiments of the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the process of the present invention described herein.

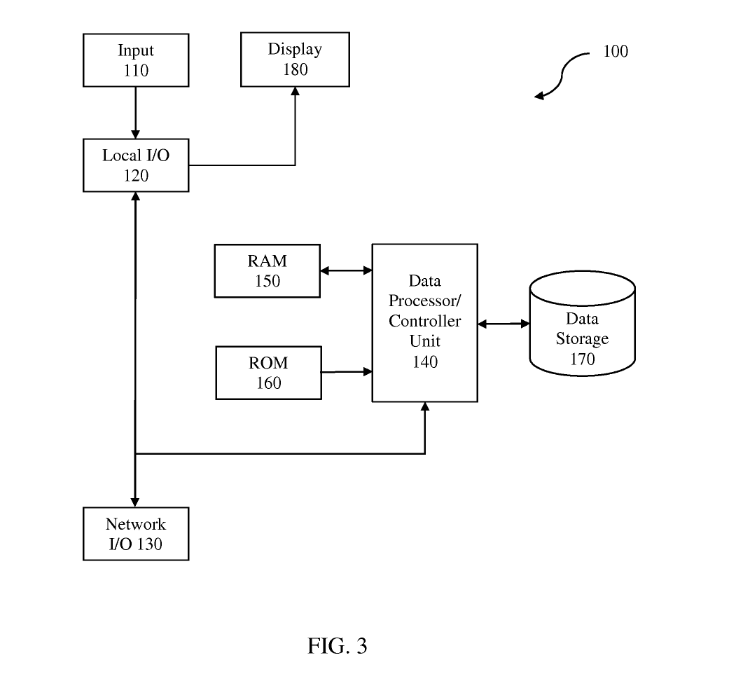

Referring to FIG. 3, there is shown a schematic block diagram illustrating an exemplary server 100, whereupon various embodiments of the present invention may be implemented. The server 100 typically includes a user input device 110 including, for example, a keyboard and a mouse. The input device 110 may be connected to the server 100 through a local input/output (I/O) port 120 to enable an operator and/or user to interact with the server 110. The local I/O 120 is also provided for local connections via direct links to other electronic devices such as a file storage, a monitor and/or a printer. The server 100 typically also has a network I/O port 130 for connection to a computer network such as the Internet, so that the server 100 may remotely communicate with the other servers connected to the computer network.

The server 100 typically has a data processor/controller unit 140 such as a central processor unit (CPU) that controls the functions and operations of the server 100. The data processor/controller unit 140 is connected to various memory devices such as a random access memory (RAM) device 150, a read only memory (ROM) device 160, and a storage device 170 such as a hard disc drive or solid state memory. The storage device 170 may be an internal memory device or an external memory device such as a file storage device.

The computer software program codes and instructions for implementing the various embodiments of the present invention may be installed or saved on one or more of these memory devices such as the ROM 160 or storage device 170. When executed, certain computer program codes and/or instructions may be read out from the ROM 160 or storage device 170 and temporarily stored in the RAM 150 for execution by the data processor/controller unit 140, which executes these computer programs codes and/or instructions to perform the functions and carry out the operations to implement the process steps of the various embodiments of the present invention.

The server 100 typically also includes a display device 180 such as a video monitor or display screen which may be connected to the local I/O 120. The input device 110 and the display device 180 together provide a user interface which allows a user to interact with the server 100 to perform the steps of the process according to the various embodiments of the present invention. The input device 110 and the display device 180 may be integrated into one unit, such as a touch screen display unit, to provide a more easy and convenient UI for user interaction with the server 100.

It is understood that the server 100 may be any suitable computer or computer system. Preferably for use, for example, by a RMS system or quiz provider service, the server 100 is a commercial server. However, for use by a member of the general public, the server 100 may be a desktop computer, a laptop computer, a notebook computer, a netbook computer, a tablet computer, a hand-held portable computer or electronic device, a smart phone, or any suitable data processing apparatus that has suitable data processing capabilities.

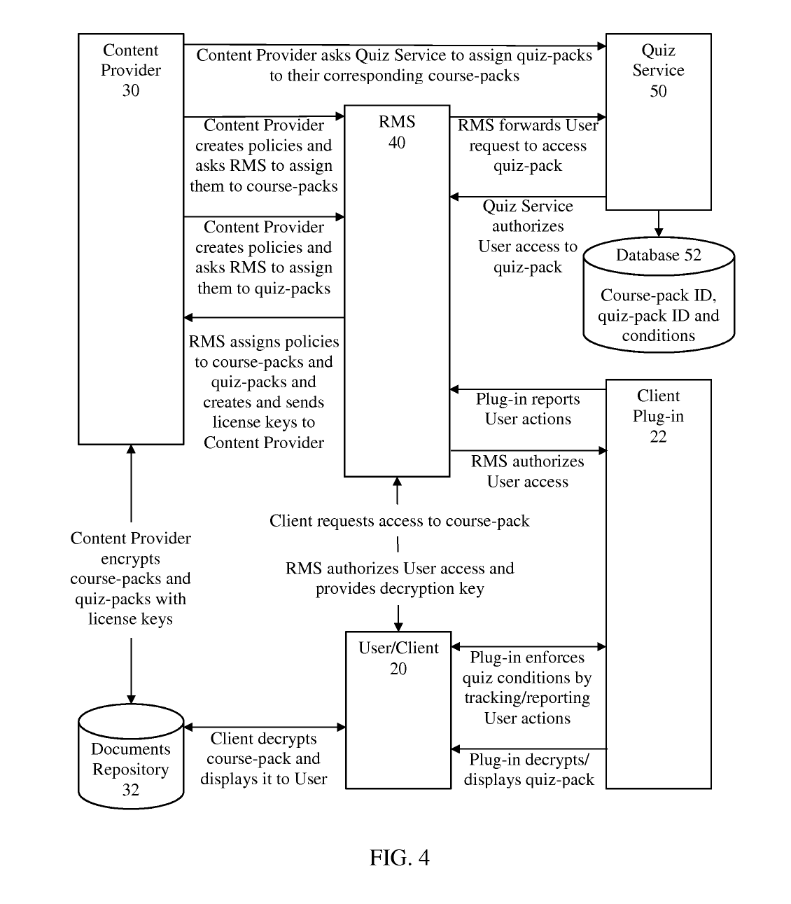

Referring to FIG. 4, there is shown a block diagram illustrating an exemplary process in accordance with to one of the embodiments of the present invention. The description herein of the structures, functions, interfaces and other relevant features, such as digital rights policies, application programming interface (API) for rights management and policies, etc., of existing DRM method and systems may at times incorporates, references or otherwise uses certain information, documents and materials from publicly and readily available and accessible open sources, e.g., “Rights Management” (URL http://help.adobe.com/en_US/livecycle/10.0/Overview/WS92d06802c76abadb2c8525912ddcb9aad9-7ff8.html), “Programmatically applying policies (a subsection of ‘Rights Management’)”, (URL http://help.adobe.com/en_US/livecycle/10.0/Overview/WSb96e41f8a4ca47a9-4882aeb5131190eddba-8000.html), “LiveCycle® ES Java™ API Reference” (URL http://livedocs.adobe.com/livecycle/es/sdkHelp/programmer/javadoc/index.html), etc.

As shown in FIG. 4, the content provider 30 generally performs the tasks of creating course-packs and corresponding quiz-packs, and also creating user policies for accessing and using the course-packs and quiz-packs. The user policies for the course-packs and corresponding quiz-packs may not be the same. For example, the course-pack policies may allow users to open and read, but not write (edit) to, a course-pack, while the quiz-pack policies may allow users to open, read and write to (e.g., fill-in answers), a quiz-pack. The content provider 30 then asks the RMS 40 to assign the user policies to the respective course-packs and quiz-packs.

Upon the requests from the content provider, the RMS 40 will assign the user policies to the respective course-packs and quiz-packs, and create encrypted license keys to the course-packs and quiz-packs. A course-pack and its corresponding quiz-pack may have different license keys, as they may be accessed at different times. However, if a course-pack and its corresponding quiz-pack are bundled in a same PDF document, then they may use the same license key. In addition, separate keys may also be used in situations, for example, when different content providers are providing a same course-pack or quiz-pack, or when a same course-pack or quiz-pack is assigned different policies for different users.

Upon receiving the license keys from the RMS 40, the content provider 30 will encrypt the course-packs and quiz-packs with their respective license keys. The encrypted course-packs and quiz-packs are saved in a document repository 32. Of course the course-packs and/or quiz-packs may also be stored as URL addresses of interactive web pages or web services, or stored locally at the RMS server 40.

The content provider will also ask the quiz service 50 to assign quiz-packs to their corresponding course-packs. This may be accomplished by generating and utilizing a quiz ID for a quiz-pack in addition to the document ID of the corresponding course-pack, and save them in a correlating table or database along with a set of related pre-conditions that must be met before the quiz-pack may be used. For example, the database table may contain mappings of a course-pack and its corresponding quiz-pack(s). It is noted that multiple quiz-packs may be associated with or assigned to a same course-pack, e.g., one quiz-pack for each chapter of the course-pack, or quiz-pack at different difficult levels (or even the same difficult level but multiple quizzes for re-taking) for taking the quiz-pack by different students or at different times or conditions. The database can be saved in a memory or data storage device 52 connected to the quiz provider's server or in the same document repository 32 where the encrypted course-packs and quiz-packs are saved.

The pre-set conditions for the users to use/take a quiz-pack may be explicit, e.g., requesting a user to select a check box after reading each page of course-pack, or pressing a “Next” button on each page of course pack, where the “Next” button will only be enabled after the user has spent a predetermined minimum period of time on the current page. The conditions may also be implicit, e.g., requiring the expiration of a cumulative period of time that the user has kept the course-pack opened, in which cases the user may not know how the course-pack usage is monitored to determine when the quiz-pack may be displayed.

A user may obtain a course-pack from the content provider 30. When a user tries to open a DRM-protected course-pack by using Client 20 at, e.g., the user's computer or terminal, the Client will establish online access to the RMS server 40 and request authorization for the user. The RMS will check the user ID, the course-pack ID and related policies. If the authorization is granted, the RMS will send a decryption key for the course-pack to the Client, so the Client can decrypt the course-pack and properly display the contents of the course-pack to the user.

In the exemplary embodiments of the present invention, a Plug-in module 22 to the Client 20 is provided, which is a set of software programming code and instructions for carrying out the additional steps related to the access and use of quiz-packs in the process of the exemplary embodiments of the present invention described herein. Plug-in 22 is compatible and can work with the Client 20 and utilize existing features and functionalities of the Client, yet provide additional features and functionalities for the user's access and use of the quiz-packs.

Plug-in 22 will enforce the pre-set conditions for using quiz-packs by monitoring. Tracking and reporting users' actions in connection with a course-pack and its corresponding quiz-pack(s). For example, will fetch the quiz-packs, check whether the pre-set conditions for using the quiz-packs are met, and monitor the use of the corresponding course-pack by the users, and allow user access to the quiz-packs when the condition are satisfied. For example, a quiz-pack might have a pre-set condition of use that a user can access it only after the user has read the whole course-pack. Plug-in 22 will also manage the user interaction with the quiz-packs. For example, once a user answers a quiz and wants to submit the answers, Plug-in 22 can send the answers to the quiz service 50. The preconditions or criteria may be applied to quiz-packs in connection with their corresponding course-packs based on metadata from an RMS or LMS server, or manually configured by the administrator of the RMS or LMS system.

As a user is using the Client 20 to study on a course-pack, the user may want to access the quiz-pack associated with the course-pack. Plug-in 22 will request a quiz-pack ID from the quiz service 50, and quiz service 50 will provide this quiz-pack ID to the user through the RMS 40 so the user can obtain the right quiz-pack stored in the document repository 32 from the content provider 30 (or the quiz service provider 50). The quiz-packs may be downloaded by the Client 20 or Plug-in 22 at the beginning along with the course-packs, or downloaded only after quiz service 50 provides authorization. Such options may be configured in the Plug-in or come as explicit request from the quiz service. When a user is using the Client 20 to try to open and use a quiz-pack, the Plug-in 22 will send the user's request to the RMS 40, which will in turn forward the request to the quiz service. Based on the report of the user's ID and actions provided by the Plug-in 22, quiz service 50 can authorize access by the user if the policy assigned to the quiz-pack allows the user's access and use of the quiz-pack, and all pre-set conditions are satisfied. When access is granted, Plug-in 22 will display the quiz to the user, and may also collect the user's answers and report them to the quiz service 50 so that, e.g., the user's answer may be graded.

Plug-in 22 may also have an offline mode, wherein the quiz service 50 pre-authorizes the Plug-in 22 to monitor the conditions, so that when the conditions are met the Plug-in 22 may display the quiz-pack to the user without obtaining a real-time online authorization from the quiz service 50.

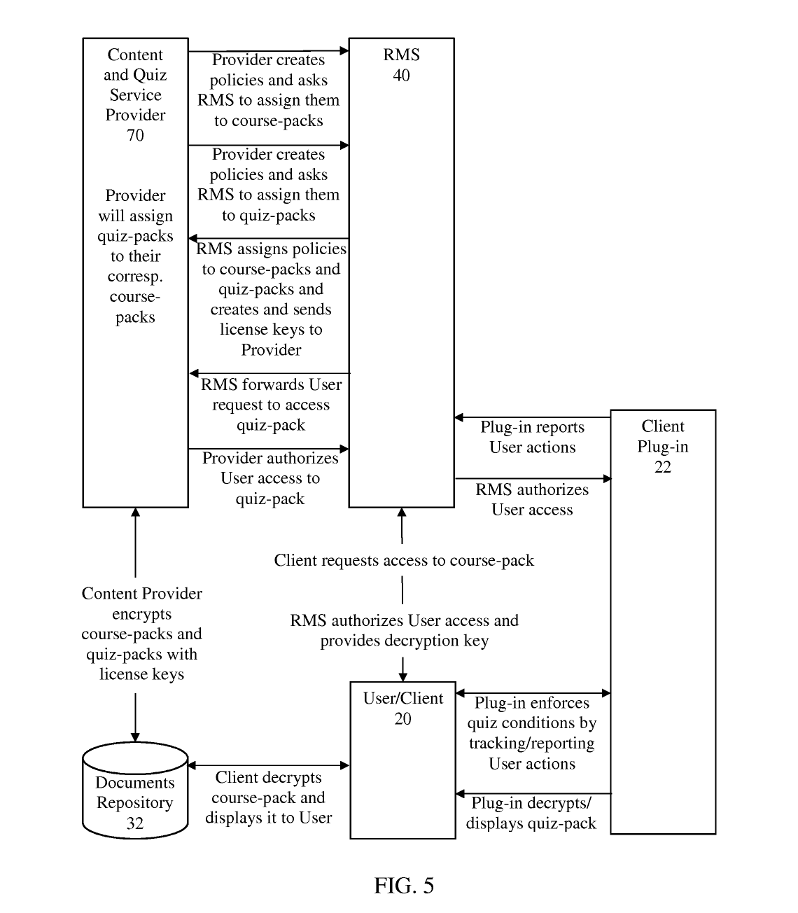

As mentioned earlier in conjunction with FIG. 2, the content provider server and the quiz servicer server may be the same server 70 operated by a same entity such as an educational institute or a commercial establishment. With this alternative arrangement, the tasks and steps handled by content provider 30 and quiz service 50 will be handled by server 70, as shown in FIG. 5.

One major advantages of the present invention is that course-packs will no longer be static documents. They will become dynamic content that can change, based on which quiz is associated with the course-pack. Another major advantage of the present invention is that quiz-packs are afforded the same level of DRM-protection as the course-packs, so that the usage of quiz-packs can be controlled through DRM-protection conditions applied to them. A further major advantage of the present invention is that it ensures that quiz-packs are available for use only after certain preconditions related to corresponding course-pack are met.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing access and use of quiz-packs by users of course-packs which may are accessed and displayed by a client application, comprising the steps of:
establishing a database with entries of correlating course-pack and quiz-pack identifications (IDs) and pre-conditions for using respective quiz-packs;
providing a plug-in program to the client application, the plug-in program tracking and reporting users' course-pack usage information;
upon a user's request for accessing and using a quiz-pack associated with a course-pack, determining whether the user has appropriate rights to access and use the quiz-pack based on the entries of the database, and also determining whether all pre-conditions are met for the user to access and use the quiz-pack based on the reported course-pack usage information, and if the user is determined to have appropriate rights and all pre-conditions are met, authorizing the user's access and use of the quiz-pack; and
when receiving the authorization to the user's access and use of the quiz-pack, the plug-in program displaying the quiz-packs.

2. The method of claim 1, further comprising the step of creating quiz-packs for course-packs.

3. The method of claim 1, further comprising the step of assigning one or more quiz-packs to a corresponding course-pack.

4. The method of claim 1, further comprising the step of creating digital right management (DRM) protection policies for quiz-packs.

5. The method of claim 4, further comprising the step of assigning DRM-protection policies to quiz-packs.

6. The method of claim 1, further comprising the step of generating license keys for quiz-packs.

7. The method of claim 6, further comprising the step of encrypting quiz-packs with the license keys.

8. The method of claim 1, further comprising the step of setting the preconditions for accessing and using respective quiz-packs.

9. The method of claim 1, further comprising the step of upon authorizing the user's access and use of the quiz-pack, providing keys for decrypting quiz-packs.

10. The method of claim 9, further comprising the step of decrypting quiz-packs with decryption keys.

11. A computer program product comprising at least one non-transitory computer usable medium having computer readable codes embodied therein for controlling one or more data processing apparatus, the computer readable codes configured to cause the one or more data processing apparatus to execute a process for managing access and use of quiz-packs by users of course-packs which may are accessed and displayed by a client application, the process comprising the steps of:
establishing a database with entries of correlating course-pack and quiz-pack identifications (IDs) and pre-conditions for using respective quiz-packs;
providing a plug-in program to the client application, the plug-in program tracking and reporting users' course-pack usage information;
upon a user's request for accessing and using a quiz-pack associated with a course-pack, determining whether the user has appropriate rights to access and use the quiz-pack based on the entries of the database, and also determining whether all pre-conditions are met for the user to access and use the quiz-pack based on the reported course-pack usage information, and if the user is determined to have appropriate rights and all pre-conditions are met, authorizing the user's access and use of the quiz-pack; and
when receiving the authorization to the user's access and use of the quiz-pack, the plug-in program displaying the quiz-packs.

12. The computer program product of claim 11, wherein the process further comprises the step of creating quiz-packs for course-packs.

13. The computer program product of claim 11, wherein the process further comprises the step of assigning one or more quiz-packs to a corresponding course-pack.

14. The computer program product of claim 11, wherein the process further comprises the step of creating digital right management (DRM) protection policies for quiz-packs.

15. The computer program product of claim 14, wherein the process further comprises the step of assigning DRM-protection policies to quiz-packs.

16. The computer program product of claim 11, wherein the process further comprises the step of generating license keys for quiz-packs.

17. The computer program product of claim 16, wherein the process further comprises the step of encrypting quiz-packs with the license keys.

18. The computer program product of claim 11, wherein the process further comprises the step of setting the preconditions for accessing and using respective quiz-packs.

19. The computer program product of claim 11, wherein the process further comprises the step of upon authorizing the user's access and use of the quiz-pack, providing keys for decrypting quiz-packs.

20. The computer program product of claim 19, wherein the process further comprises the step of decrypting quiz-packs with decryption keys.
